(19) United States
(12) Patent Application Publication
(10) Pub. No.: US 2020/0267890 A1
(43) Pub. Date: Aug. 27, 2020

(54) Infrared Contrast Image Apparatus for Viability Test of the Dormant Seeds

(71) Applicant: Lev Matvey Vozchikov, Stamford, CT (US)

(72) Inventor: Lev Matvey Vozchikov, Stamford, CT (US)

(21) Appl. No.: 16/285,229

(22) Filed: Feb. 26, 2019

(51) Int. Cl. A01C 1/02; G01N 21/3504

(52) U.S. Cl. CPC A01C 1/025; A01C 2001/048; G01N 21/3504

(57) ABSTRACT

Invention is the innovative apparatus to determine plant seeds quality rate in a dormant stage. Aim of the invention is measuring quantity of carbon dioxide radiance on active seeds to calculate average of the germination, the vigor, and a proportion of the value of the light radiated seeds to calculate viable. Apparatus use process of the spectral lighting to warm up seeds to obtain thermal contrasting Infra-red images, to visualize seeds embryos metabolism. The contingent seeds embryos intensity of the radiance is taken in account to determine seeds measurement of the viability, of the vigor indicative. Due to order to create the specimen seed embryo radiometric profile data, recording digital images of the seed unit's specimen data enable to derive, and then calculate the Infra-red contrast value of seed specimen profile. Light titrations of the seeds thermal exposition, due to seeds specimen rotation, eliminate irregularity of the seed layer lighting.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND

Invented apparatus technology applicable for the Infra-red testing the dormant plant seeds quality in the pre-germination stage. Determination quality of the dormant seeds allow regulating of the plant propagation economy. Apparatus of the technological quality test processing contain carbon dioxide (CO₂) spectrum band, longwave thermal imager, light titration turntable, quartz lamp, and CO₂ calibration to precede digital recording a contrast thermal image of the seeds embryos. Infra-red contrast lighting technique achieve hue indicatory, visualization and measure seed embryonic CO₂ concentration, the seed metabolism product, as shown on the embryo pictogram.

### BRIEF DESCRIPTION

Invention is the apparatus to record longwave images of the plant seeds, in aim to create the thermal profile of the dormant seeds embryo. Invention pursue purpose to provide selection of viable seed, measure specimen vigor in dormant stage. Apparatus include the quartz lamp, for specimen contrast lighting in a longwave spectrum, which is pointed directly on to the seed specimen. Seed specimen resided on the light titration device, motorized turntable for rotation. A seeds sample is in a rotating due to order to luminous exposition, to eliminate halogen lamp light irregularity. Apparatus include a longwave CO₂ calibrated thermal imager camera that necessary to record seed metabolism product, seed radiometric image. Process of the limited radiant thermal exposure of specimen allow to achieve seeds warming, Infra-red light contrasting of the end use records of the radiometric imaging. Technologically the quality of the dormant seeds, in provisions of thermal radiance contrast value, defined as indicative of the viability, vigor and is the rate grading factor for the seeds specimen germination efficiency. Invention utilize CO₂ band, longwave contrast imaging technique to select and calculate seeds with an actual grade of the unit status, for measuring seed unit radiance in a plant seeds specimen. Economic outcome of the described apparatus is the advantage of the nondestructive plant seeds mass quality grading in the pre-germination stage.

### DETAILED DESCRIPTION OF INVENTION

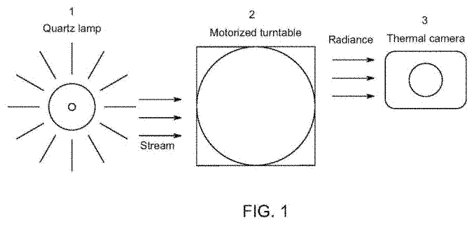

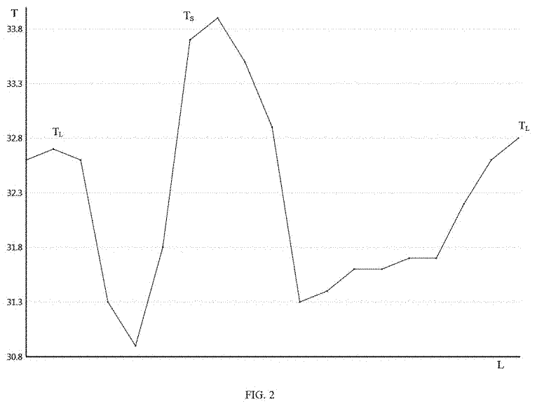

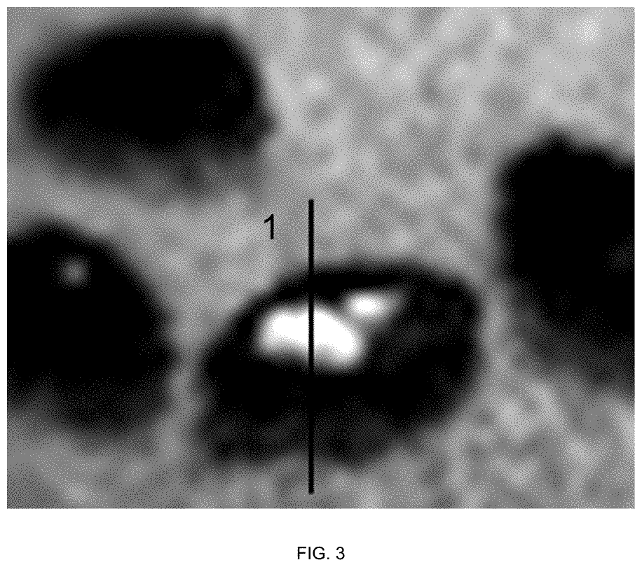

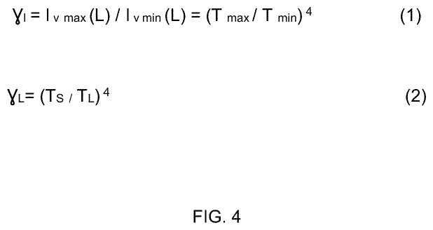

Invention, an apparatus for the contrasting thermography as shown on the FIG. 1, includes 1, halogen quartz lamp, lamp pointed directly to light up the circularly rotating base for the light titration, motorized turntable 2. The seed specimen resided on the motorized turntable surface layer for light exposition and titration. A plant seeds specimen exposing to the quartz lamp through the emitted light thermal stream, to light up plant seed cluster in a contrast γ_{I}, given by formula (1), to create contrasting γ_{L}. (layer-seed surface) of the thermal profile given by equation (2), as shown in the FIG. 2. The light titration technique, seed specimen rotation, eliminate irregularity of the light source to provide identical exposition of each seed units in an equal rotating treks. Thermal image camera—the longwave imager 3 pointed to the seed specimen to acquire the record of the radiometric data image, immediately after exposure to the light stream from quartz lamp 1, as shown on the FIG. 3. The thermal radiance aperture of the CO₂ band spectrum of the seeds recording, and measuring by thermal imager, longwave camera to create a thermal profile of the specimen seed unit, to determine radiance contrast values by given formulas (1), (2) as shown on the FIG. 4. Apparatus, calibrated in a CO₂ spectrum, support measure of the concentration profile of the CO₂, as a product of seed metabolism. Seed unit physical property, the thermal image profile, depict the layer-seeds surfaces radiance intensity contrast in proportion to the CO₂ concentration in a dormant seed. Seed metabolism presented through the embryo radiance image. The active seed status, indicated by the CO₂ radiance, is determine the selection of the viable gradation seed for a dormant stage. Positive value of the seed/layer contrast 1 indicate dormant seed viability, instead negative rate of the seed/layer contrast <1 is a sign of a nonviable seed. Average of the radiance distributive allow measure of the CO₂ concentration value to determine the vigor of the seeds specimen. The dormant stage seed longwave radiance intensity value there has engaged as indicator of the plant viable.

### DRAWINGS

### Drawings Listing

1. There on the FIG. 1 shown Optical scheme of apparatus. There 1-Quartz lamp, 2-Light titration seed station, motorized turntable, 3-Thermal camera imager.

2. There on the FIG. 2 shown belonging to the Seed of the Rosa Rugose thermal profile of the radiance aperture. There T temperature, ° C., L seed profile, mm. Ts (° C.) seed temperature, T_{L} (° C.) layer temperature.

3. There on the FIG. 3, I have shown Rosa Rugose specimen thermal image of the seed embryo, there 1, as shown, is the thermal profile of the seed.

4. There on the FIG. 4 shown contrast γ_{I} radiometric image formula 1, contrast γ_{L} seed profile formula 2. There I (W/μm cm²) total radiant intensity, I_{v max} (L), I_{v min} (L), inbound radiance intensity, T_{min,} Tₘₐₓ (° C.) image cluster temperature, L—specimen thickness geometry, cm. Ts (° C.) seed temperature, T_{L} (° C.) layer temperature.

1. Apparatus contain a light titration, the motorized seed specimen layer rotator, titration to eliminate irregularity of the exposure by the quartz light lamp, rotator include motorized turntable, the seeds specimen layer holder, to rotate seeds specimen with constant speed due to exposure to the light beam.

2. Apparatus contain thermal Infra-red imager calibrated within CO₂ band instrumental spectrum, thermal imager band spectrum overlap CO₂ radiance band to record and measuring CO₂ concentration profile in a seeds specimen.

3. Apparatus utilizes the lighting thermal contrasting method to visualize plant seeds viability measure in dormant stage, visualization viability and vigor measure determine quality grade of the seed unit by technical measuring seed embryo CO₂ radiance aperture, by measuring the temperature contrast to the temperature of layer due to thermal light exposure.

4. Apparatus permit to select viable seeds of the specimen distributive, support measure of the seeds vigor value, the determination of the seed germination distribution correlation with dormant seeds embryos radiance distribution, there CO₂ longwave Infra-red seeds embryo radiance value is engaged as the indicator of the carbon dioxide concentration measuring.
